(19) United States
(12) Patent Application Publication
(10) Pub. No.: US 2009/0133709 A1
(43) Pub. Date: May 28, 2009

(54) HAIR CURLER

(75) Inventor: Kazutoshi Kaizuka, Fukouka City (JP)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CREATE CO., Fukouka City (JP)

(21) Appl. No.: 12/332,625

(22) Filed: Dec. 11, 2008

Related U.S. Application Data
(63) Continuation of application No. 10/664,682, filed on Sep. 19, 2003, now abandoned.

(51) Int. Cl. A45D 1/04; A45D 1/00; C08K 3/34

(52) U.S. Cl. 132/229; 132/269; 219/226; 524/437

(57) ABSTRACT

A hair curler that can rapidly impart a strong, attractive curl without causing damage or loss of shine, and which can reduce setting time. The hair curler has a curler body formed of a heat resistant resin to which are admixed silicon dioxide based multi-element mineral powder, formed by crushing a multi-element mineral, and a far-infrared emitting powder, formed by crushing a far-infrared emitting material.

### CROSS-REFERENCE TO RELATED APPLICATIONS

This application claims the benefit of priority under 35 U.S.C. 120 of U.S. patent application Ser. No. 10/664,682, filed Sep. 19, 2003, which is incorporated herein by reference in its entirety.

### BACKGROUND OF THE INVENTION

1. Field of the Invention

The present device relates to an improved plug-in type hair curler having an internal heater incorporated within the curler body.

2. General Background and State of the Art

Hair curlers are known which have a cylindrical body with bristles are prongs extending radially outward. These types of hair curlers are heated for example by an electrical current flows through an internal heater which generates heat, and after heating the hair curler body, it is removed from the heater and hair is wrapped around the hair curler and held in place by a pin, so as to impart a curl to the hair (for example, see Unexamined Japanese Utility Model Publication JP-05-28790-U).

However, as the bodies of such conventional hair curlers were simply formed of plastic, there were problems such that when these were used to impart a curl to the hair, the hair was damaged by the heat, the hair lost shine, and it was difficult to set fine hair. Furthermore, since the thermal retention efficiency of the plastic was poor, it was not possible to reduce the setting time.

There have been attempts to some of the problems in conventional hair curlers. There exist hair curlers formed of a heat resistant resin to which is admixed a multi-element mineral powder, formed by crushing a multi-element mineral as discussed for example in Examined Japanese Utility Model Publication JP-3045250-U.

However, even with this hair curler, there was a problem in that the conventional problems were not fully solved.

### INVENTION SUMMARY

As the hair curler of the present device was intended to solve problems associated with conventional hair curlers, an object of the present invention is to provide a novel hair curler having such characteristics as the ability to rapidly impart a strong, attractive curl, while avoiding damage to the hair and loss of shine, as well as reducing setting time, and wherein hair to which a curl has been imparted by the hair curler remains set for a long period of time as compared to conventional curlers.

The hair curler of the present device is a hair curler of the plug-in type, wherein an internal heater is incorporated in the interior of the curler body; the curler body has a constitution wherein this is formed from a heat resistant resin to which are admixed a multi-element mineral powder, made by crushing a multi-element mineral, and a far-infrared emitting powder, made by crushing a far-infrared emitting material.

### BRIEF DESCRIPTION OF THE DRAWINGS

FIG. 1 is a schematic view illustrating a situation wherein hair curlers according to this mode of embodiment are mounted on the plugs of a hair curler mounting base.

### DETAILED DESCRIPTION OF THE PREFERRED EMBODIMENTS

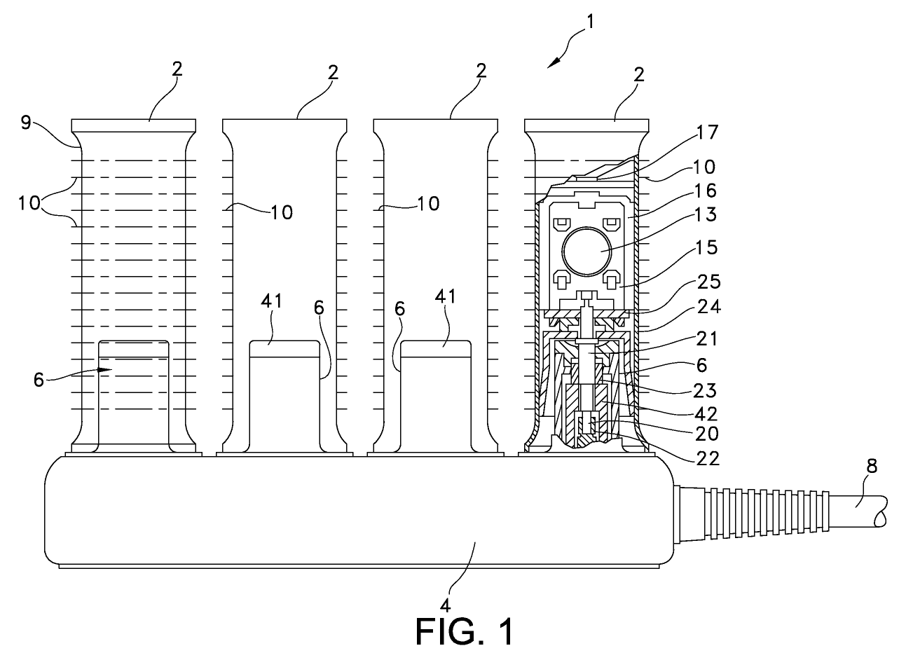

FIG. 1 is a schematic, partial cross-sectional view illustrating a hair curler assembly 1 according to the invention. The hair curler assembly includes hair curlers 2 mounted on a hair curler mounting base 4, having a plurality of curler mounts 6 and a power cord 8.

In the present invention, the hair curlers 2 have a preferably cylindrical curler body 9 and may include protusions 10 extending radially outward from the curler body 9. The hair curlers 2 also define a recess 11 designed to fit over and accept the curler mounts 6.

The curler body 9 is designed to be rolled into the hair to impart a curl to the hair, and therefore, the curler body 9 is a cylinder formed from a heat resistant resin into which are admixed a multi-element mineral powder, formed by crushing a multi-element mineral, and a far-infrared emitting powder, formed by crushing a far-infrared emitting material. In the present embodiment, a polyester elastomer is used for the heat resistant resin. The plurality of protrusions 10 may be bristles, prongs or ribs, formed at the outer periphery of the curler body 9.

In the hair curler 2 of the present device, the curler body is formed from a heat resistant resin to which are admixed a multi-element mineral powder, formed by crushing a multi-element mineral, and a far-infrared emitting powder, formed by crushing a far-infrared emitting material, and therefore, a clustering effect (the size of groups of water molecules is reduced) is produced in the water in the hair as a result of the negative ions emitted by the multi-element mineral, penetration of the hair by water is promoted, outflow of the intracellular substance (matrix) is limited, and the hair is rendered healthy.

Use of the hair curlers 2 provides effects wherein the hair is made lustrous as a result of negative ions, and the negative ions act on the hair cuticles (glass-like fibers) so that good luster is maintained at all times. This is particularly effective for damaged hair and unmanageable hair.

The hair curlers 2 emit electromagnetic waves with wavelengths of 4 to 14 μm (weak energy) emitted by the multi-element minerals electrically modify the surroundings of the nuclei of atoms and cause an excited state (oscillation) in the atoms and substances comprising the same. Consequently, water cluster polymers are cleaved and shortened, the volume of the water is reduced, and the specific gravity is increased. This results in sufficient contact of the outer membranes of animal cells by the water (free water), promotes the permeation of the cell by both Ca⁺ and water, and has the effect of activating various cellular functions. Accordingly, this allows for care of the hair.

The far-infrared emitted from the far-infrared emitting powder heats the hair from the inside. Consequently, penetration of the hair by water is promoted and the hair can be maintained in a healthy state.

Examples of far-infrared emitting materials include alumina (Al₂O₃), titania (TiO₂), ferrite (Fe₂O₃), chromium oxide (Cr₂O₃), silica (SiO₂), yttria (Y₂O₃), magnesia (MgO).

The multi-element mineral and the far-infrared emitting material are, for example, powdered by grinding these to 0.5 to 3 microns, and preferably 0.5 to 1 micron in a bowl mill or the like, and this is admixed to a polyester elastomer. The ratio of the multi-element mineral and the far-infrared emitting material to the polyester elastomer is such that the volume or weight of both powders is between 0.5% and 5% and preferably approximately 1% to 3% of the weight of the polyester elastomer. The powder may be directly admixed to the polyester elastomer, or the powder may be mixed with water, and after heating or pressurization, the supernatant may be directly admixed to the polyester elastomer, or a powder produced by freeze-drying or spray-drying may be admixed to the polyester elastomer.

The term multi-element mineral refers to minerals comprising a good balance of a plurality of elements, such as pitchstone or perlite, which are composed primarily of silicon dioxide. The multi-element mineral, such as perlite, is ground in a bowl mill or the like to 1 to 3 microns to form a multi-element mineral powder. It is preferable that two or more types of multi-element mineral powders be blended, but one type alone may be used. Note that perlite has the following composition:

TABLE 1

| | |
|---|---|
| silicon dioxide (SiO₂) | 71.94% |
| aluminum oxide (Al₂O₃) | 14.94% |
| ferrous oxide (Fe₂O₃) | 2.54% |
| magnesium oxide (MgO) | 0.44% |
| calcium oxide (CaO) | 2.47% |
| alkali oxide (K₂0 + Na₂O) | 6.87% |
| manganese oxide (MnO) | 0.03% |
| phosphoric anhydride (P₂O₅) | 0.14% |
| ignition loss | 3.43% |
| drying loss (at 110° C.) | 0.07% |
| other, titanium | Trace |

The far-infrared emitting material, alumina (Al₂O₃), titania (TiO₂), ferrite (Fe₂O₃), chromium oxide (Cr₂O₃), silica (SiO₂), yttria (Y₂O₃), magnesia (MgO), can be ground to form powders, which can be used singularly or in combinations of two or more.

The curler mounts 6 are designed to be inserted into the recess 11, so that the mounting stand 4 can heat the internal heater 13 of the hair curlers 2. The curler mounts 6 comprises a central conductor 20 and an outer conductor 21; and these are electrically connected to two heat radiating plates 16 in the hair curlers 2 which serve as electrodes (the front heat radiating plate is not shown in the drawing), which are arranged so as to be in contact with the two sides of the heater 13, which is fitted in a heater guide 15. Accordingly, when hair curlers 2 are mounted on the curler mounts 6, current flows through the heater 13. Note that, in the figure, reference numeral 22 indicates a terminal for the central conductor 20, reference numeral 23 indicates a terminal for the outer conductor 21, and reference numeral 24 indicates a connecting plate which connects the central conductor 21 to one of the heat radiating plates 16. The connecting plate that connects the outer conductor 21 and the other heat radiating plate is not shown. Reference numeral 25 indicates a plug caulking mount.

The heater 13 serves to heat the curler body 9. In the present embodiment, a PTC thermistor is used as heater 13. Note that, in the drawing, reference numeral 41 indicates a cap for the curler mount 6. A thermolabel 17 is provided on the hair curlers 2 which displays when the curler body 9 has reached a suitable temperature, for example, thermolabel 17 is red before heating and turns black after heating.

Thus, when the hair curlers 2 according to the present embodiment are used, as shown in FIG. 1, the hair curlers 2 are placed on the curler mounts 6 of the hair curler mounting stand 4 so that electrical current flows through the heater 13, and the hair curlers 2 are heated to a predetermined temperature. Next, when the hair curlers 2 reach the predetermined temperature, the hair curlers 2 are removed, rolled into the hair, and fixed with a pin (not shown) to impart a curl.

In the hair curlers 2 of the present embodiment, the curler body 9 is formed from a polyester elastomer to which is admixed a multi-element mineral powder, formed by crushing a multi-element mineral, and a far-infrared emitting powder, formed by crushing a far-infrared emitting material, and therefore, negative ions, weak energy, and far infrared are generated from the curler body 9; this reduces the size of the groups of molecules in the water so that it penetrates deep within the hair, whereby the moisture balance of the hair is adjusted so that the condition thereof approaches a healthy state and a strong and attractive curl can be imparted. As a result of activation of proteins in the hair by the action of the negative ions, the weak energy, and the far infrared, the hair can be constantly maintained in a healthy state. As the thermal efficiency can be increased by the action of the negative ions, the weak energy, and the far infrared, and thereby the setting time can be reduced. Furthermore, negative ions, weak energy, and far infrared act to reduce the size of the groups of molecules in the water so that it penetrates deep within the hair, thus reducing static electricity and maintaining shiny hair. Furthermore, negative ions, weak energy, and far infrared act so that it is possible to impart an attractive curl to hair that has been damaged by excessive use of hair coloring, permanent wave treatments, and hair dryers, and to fine hair that is difficult to set.

Above, a mode of embodiment of the present device has been described, but the specific constitution of the present device is not limited to this mode of embodiment, and the present device can include modifications without departing from the scope and the spirit of the device.

As described above, in the hair curler of the present device, the curler body 9 is formed from a heat resistant resin to which are admixed multi-element mineral powder, formed by crushing a multi-element mineral, and far-infrared emitting powder, formed by crushing a far-infrared emitting material, whereby negative ions, weak energy, and far infrared are generated from the curler body, which mineralize the water in the hair and activate the proteins in the hair so that the hair is constantly healthy and shiny. The negative ions, weak energy, and far infrared act to reduce the size of the groups of molecules in the water so that it penetrates deep within the hair, whereby the moisture balance of the hair is adjusted so that the condition thereof approaches a healthy state, and a strong and attractive curl can be imparted. As the thermal efficiency can be increased by the action of the negative ions, the weak energy, and the far infrared, the setting time can be reduced. Furthermore, negative ions, weak energy, and far infrared act to reduce the size of the groups of molecules in the water so that it penetrates deep within the hair, thus reducing static electricity and maintaining shiny hair.

1. A hair curling apparatus comprising:
a base having a curler mount adapted to provide electric power;
a cylindrical curler body having a plurality of radially extending protrusions;
the curler body comprising a mixture of a heat-resistant resin, a silicon dioxide-based multi-element mineral powder, and a far-infrared emitting powder;
the multi-element mineral powder including silicon dioxide powder and aluminum oxide powder;
the far-infrared emitting powder including silica powder and alumina powder;
the curler body having a recess and an internal heater adapted to heat the curler body; and
the recess being adapted to receive the curler mount to provide power to the internal heater; and
the mixture being adapted to cause the curler body to emit electromagnetic waves of 4 to 14 microns when the curler body is heated by the internal heater.

2. The hair curling apparatus of claim 1 wherein the mixture comprises between 0.5% and 3% by weight of the multi-element mineral powder and the far-infrared emitting powder.

3. The hair curling apparatus of claim 1 wherein the heat-resistant resin is a polyester elastomer.

4. The hair curling apparatus of claim 1 further comprising a thermolabel on the curler body to indicate the temperature of the hair curling apparatus.

5. The hair curling apparatus of claim 1 wherein the mixture comprises between 0.1% and 3% by weight of the multi-element mineral powder and the far-infrared emitting powder.

6. The hair curling apparatus of claim 1 wherein the mixture comprises between 0.5% and 5% by weight of the multi-element mineral powder and the far-infrared emitting powder.

7. The hair curling apparatus of claim 1 wherein the far-infrared emitting powder includes additionally at least one of titania, ferrite, chromium oxide, yttria and magnesia powder.

8. The hair curling apparatus of claim 1 wherein the multi-element mineral powder additionally includes at least one of ferrous oxide, magnesium oxide, calcium oxide, alkali oxide, manganese oxide and phosphoric anhydride.

9. The hair curling apparatus of claim 1 further comprising the heat-resistant resin being a polyester elastomer, a thermolabel in the curler body to indicate the temperature of the hair curling apparatus, and the mixture comprising between 0.1% and 3% by weight of the multi-element mineral powder and the far-infrared emitting powder.

10. The hair curling apparatus of claim 1 wherein the mixture comprises between 0.1% and 2% by weight of the multi-element mineral powder and the far-infrared emitting powder.

11. The hair curling apparatus of claim 1 wherein the far-infrared emitting powder additionally includes at least one of titania, ferrite, chromium oxide, yttria and magnesia powder, and the multi-element mineral powder additionally includes at least one of ferrous oxide, magnesium oxide, calcium oxide, alkali oxide, manganese oxide and phosphoric anhydride.

12. The hair curling apparatus of claim 1 wherein the far-infrared emitting powder additionally includes at least two of titania, ferrite, chromium oxide, yttria and magnesia powder.

13. The hair curling apparatus of claim 1 wherein the multi-element mineral powder additionally includes at least two of ferrous oxide, magnesium oxide, calcium oxide, alkali oxide, manganese oxide and phosphoric anhydride.

14. The hair curling apparatus of claim 1 wherein (1) the mixture comprises between 0.1% and 2% by weight of the multi-element mineral powder and the far-infrared emitting powder, (2) the far-infrared emitting powder additionally includes at least one of titania, ferrite, chromium oxide, yttria and magnesia powder, and (3) the multi-element mineral powder additionally includes at least one of ferrous oxide, magnesium oxide, calcium oxide, alkali oxide, manganese oxide and phosphoric anhydride.

15. The hair curling apparatus of claim 14 wherein the heat-resistant resin is a polyester elastomer.

16. The hair curling apparatus of claim 1 wherein the mixture causes the curler body when heated by the internal heater to generate negative ions, weak energy and far-infrared radiation.

17. The hair curling apparatus of claim 1 wherein the electromagnetic waves are sufficient when the curler body is heated and in use on head hair of a user to enhance and promote cell activities and improve blood circulation of the scalp of the user.

18. A method of forming a hair curler having a curler body and protrusions extending radially out from the curler body and the curler body having a recess for receiving therein an internal heater, the method comprising:
crushing a far-infrared emitting material to form a far-infrared emitting material powder;
crushing a multi-element mineral to form a multi-element mineral powder;
mixing into a heat resistant resin the far-infrared emitting material powder and the multi-element mineral powder to form a mixture;
the multi-element mineral powder including silicon dioxide powder and aluminum oxide powder,
the far-infrared emitting material powder including silica powder and alumina powder; and
the mixture being adapted to cause the curler body to emit electromagnetic waves of 4 to 14 microns when the curler body is heated by the internal heater.

19. The method of claim 18 wherein the mixture causes the curler body when heated by the internal heater positioned in the recess to generate negative ions, weak energy and far-infrared radiation.

20. The method of claim 18 wherein the electromagnetic waves are sufficient when the curler body is heated and in use on head hair of a user to enhance and promote cell activities and improve blood circulation of the scalp of the user.

21. The method of claim 18 wherein (1) the mixture comprises between 0.1% and 2% by weight of the multi-element mineral powder and the far-infrared emitting powder, (2) the far-infrared emitting powder additionally includes at least one of titania, ferrite, chromium oxide, yttria and magnesia powder, (3) the multi-element mineral powder additionally includes at least one of ferrous oxide, magnesium oxide, calcium oxide, alkali oxide, manganese oxide and phosphoric anhydride, and (4) the heat-resistant resin is a polyester elastomer.
